(19) United States
(12) Patent Application Publication
(10) Pub. No.: US 2007/0096461 A1
(43) Pub. Date: May 3, 2007

(54) Crimped hose fitting

(76) Inventor: Carl H. Owens, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/265,891

(22) Filed: Nov. 3, 2005

(51) Int. Cl. F16L 33/00

(52) U.S. Cl. 285/256

(57) ABSTRACT

A fitting for a flexible hose, the fitting having. a malleable ferrule and a stem member, with a plurality of projection members disposed on the interior of the ferrule and a corresponding plurality of channels disposed on the exterior of the stem member, wherein prior to crimping the fitting onto the hose the projection members are not aligned with the channels but are properly spaced such that upon elongation of the ferrule during the crimping operation the projection members are properly aligned with the channels.

### BACKGROUND OF THE INVENTION

This invention relates generally to the field of hose fittings, and more particularly to fittings, couplings or connectors joined to the ends of flexible hoses by crimping, where the fittings comprise an internal stem member and an external ferrule or sleeve member.

In order to connect flexible hoses to other components, it is well known to attach metal fittings, couplers or connectors to the hose ends. The fittings typically comprise two components an internal stem member having a shank or stein that is inserted into the interior of the hose and an external ferrule or sleeve member that is disposed externally about the hose end and interlocks of connects with the stem member such that relative movement in the axial direction is precluded. The ferrule is composed of a malleable metal, such that it can be inwardly deformed in the radial direction by a crimping process such that protrusions, ridges or the like are created in the ferrule which press into the compressible hose, thereby securing the fitting to the hose end.

It is obviously very important in high pressure hoses that the fitting be securely affixed to the hose. At the same time, care must be taken to insure that maximizing the security of the fitting and hose combination does not impart excessive stress into the hose, which can lead to catastrophic failure.

In one common type of fitting, the shank of the stem member is provided with a series of annular channels at spaced intervals, the channels either formed in the body of the stem member or created by annular ridges or raised portions extending out from the body of the stem member. The tubular ferrule is provided with a series of annular internal annular projection members, such as ridges, barbs or raised areas, which correspond in position to the channels on the stem member. When the ferrule is crimped and deformed to secure the fitting to the hose, the combination of the annular projections and annular channels compress the hose end into a series of corresponding annular hills and valleys.

A problem with this well known type of fitting is that no consideration is given to the fact that when the ferrule is crimped deformation in the axial direction occurs in addition to deformation in the radial direction. Testing reveals, for example, that a ferrule may elongate roughly 7.5 percent from its non-deformed dimensions. This elongation results in alteration of the spacing and positioning of the annular projection members in the axial direction, meaning that the annular projections are no longer precisely aligned with the annular channels on the stem after the crimping operation. This results in unwanted stress points and a less than optimum connection between the fitting and the hose, reducing the working integrity of the hose and fitting combination and increasing the likelihood of failure in the fitting connection or breach of the hose wall.

It is an object of this invention to address this problem by providing a fitting for a flexible hose that accounts for the axial elongation of the ferrule relative to the shank of the stem member during the crimping operation, such that the annular internal projections of the ferrule properly align with the annular channels of the shank after the fitting has been secured to the hose end, and in a manner such that there is less compression and deformation than with traditional crimping methods.

### SUMMARY OF THE INVENTION

The invention is in general a fitting, connector or coupling for a flexible hose end and the combination of such a fitting and hose, wherein the fitting comprises a stem member having a hollow shank or stem that is inserted within the bore of the flexible hose and a ferrule or sleeve that externally surrounds the end of the hose, the ferrule being composed of a malleable metal such that it may be crimped onto the hose end and shank to secure the fitting to the hose. The fitting may be provided as a single piece member, or the ferrule may be separate from the stem member and joined during the crimping operation.

The external surface of the shank of the stem member is provided with a series of axially spaced annular channels. The interior surface of the ferrule is provided with a series of axially spaced annular internal projection members, wherein the axial spacing of the annular internal projection members differs from the axial spacing of the annular channels. The axial spacing of the annular internal projection members is smaller than that of the annular channels in order to account for the elongation of the ferrule resulting from the crimping operation, such that upon crimping the axial spacing of the projection members will correspond to the axial spacing of the channels and the projection members will be properly aligned with the channels.

### BRIEF DESCRIPTION OF THE DRAWINGS

FIG. 1 is a cross-sectional view of a fitting shown prior to crimping the ferrule onto the stem member, illustrating that the spacing of the projection members on the ferrule is different than the spacing of the channels on the stem member.

FIG. 2 is a cross-sectional view of the fitting of FIG. 1 with the ferrule shown as crimped onto the stem member, illustrating that the projection members properly align with the channels due to elongation of the ferrule.

FIG. 3 is a cross-sectional view of an alternative embodiment of a fitting similar to that of FIG. 1, wherein the fitting is a single-piece member.

FIG. 4 is a cross-sectional view of an alternative embodiment of a fitting similar to that of FIG. 2, wherein the fitting is a single-piece member.

FIG. 5 is a partial cross-sectional view showing the optimum alignment position of a stem member channel.

### DETAILED DESCRIPTION OF THE INVENTION

With reference to the drawings, the invention will now be described with regard for the best mode and the preferred embodiment. In general, the invention is crimped fitting for a flexible hose, or the combination of such fitting and hose, wherein the fitting comprises a ferrule having at least one and more preferably a plurality of internal annular projection members and a stem member- having at least one and more preferably a plurality of channels, whereby the projections members properly align with the channel members after the ferrule is elongated by the crimping process. The term fitting shall be taken herein to comprise structures, commonly referred to as fittings, connectors, couplings or the like, that provide a mechanism for connection of the flexible hose to another component. The term flexible hose shall be taken herein to include hoses composed. of rubber, synthetics or the like, whether or not reinforced, that are capable of being compressed such that a fitting having a deformable ferrule can be securely connected to the hose end.

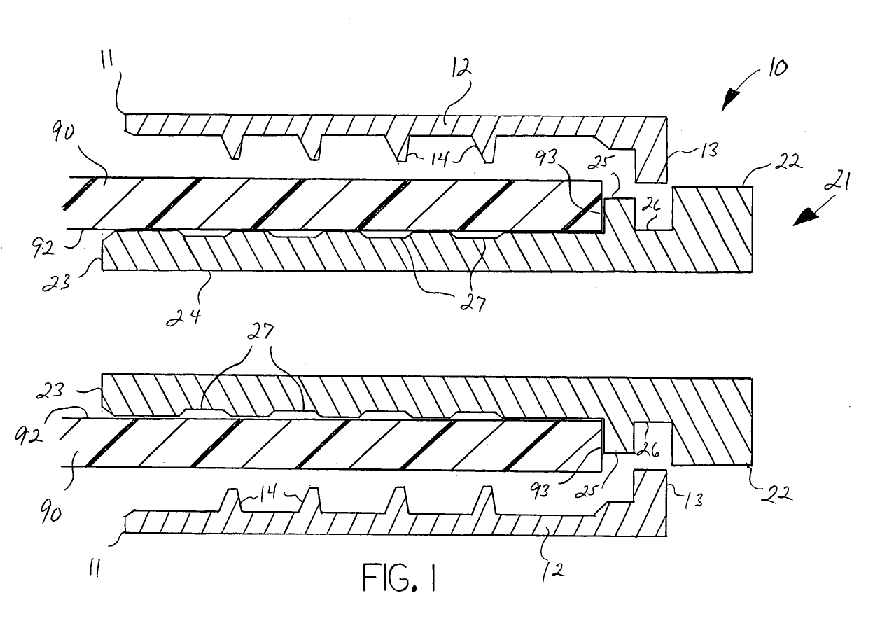

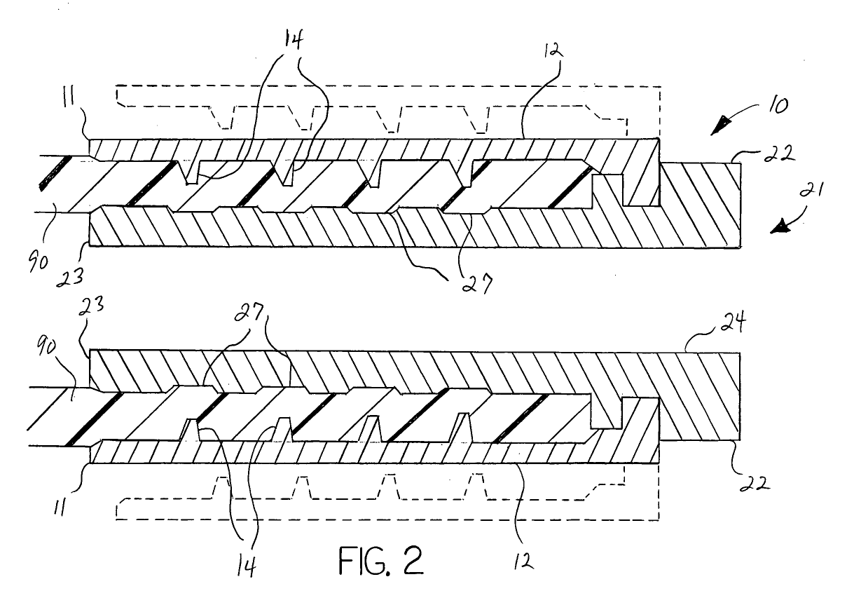

FIGS. 1 and 2 illustrate a fitting 10 comprising a ferrule or sleeve member 11 and a stem member 21, wherein the ferrule 11 and the stem member 21 are individual and separate components prior to the joining operation. The stem member 21 comprises a head or connector portion 22 adapted to be joined to another component of the system, where the head 22 may be threaded, slotted, etc. in order to securely connect to the other component. An elongated hollow shank member 23 extends in the opposite direction from the head 22, the bore 24 defining a longitudinal axis for the stem member 21. Means to retain the ferrule 11 is provided, which as shown comprises an interlock shoulder 25 and interlock groove 26.

The ferule 11 is composed of a malleable metal material and comprises a generally tubular, relatively thin-walled, sleeve body 12 and an interconnecting annular flange member 13 adapted to be received and retained by the stem member 21 such that the ferrule 11 cannot be removed from the stem member 21 after the crimping operation. The interior surface of the sleeve body 12 is provided with at least one and more preferably a series or plurality of axially spaced, internal annular projection members 14, often referred to as barbs, ridges or the like. The spacing and configuration of the projection members 14 may vary, and the projection members 14 may be segmented but are preferably continuous over 360 degrees. For example, the projection members 14 may be evenly spaced in the axial direction, may have increasing or decreasing spacing between each projection member 14, or may be randomly or variably spaced. The dimensions and configuration of the projection members 14 may vary and will often depend on the particular composition of the hose 90 to which the fitting 10 is to be attached.

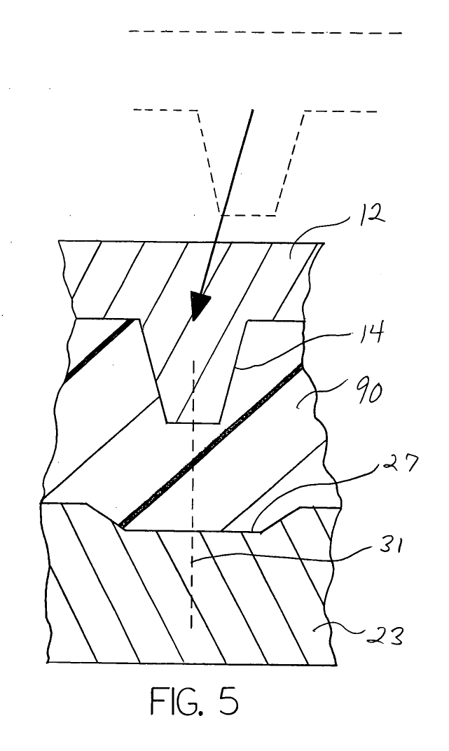

The exterior of the shank 23 is provided with at least one and more preferably a series of axially spaced annular channels 27. The channels 27 may be structured as recesses cut into the surface. of the shank 23 or as recesses defined by ridges or raised areas disposed on the surface of the shank 23. The spacing and configuration of the channels 27 may vary, and the channels 27 may be segmented but are preferably continuous over 360 degrees. For example, the channels 27 may be evenly spaced in the axial direction, may have increasing or decreasing spacing between each channel 27, or may be randomly or variably spaced. The depth, width and angle of the walls and bottoms of the channels 27 may vary, depending on the dimensions of the projection members 14 and the composition of the hose 90. Each channel 27 will however have an optimum alignment position 31, as shown in FIG. 5, for receiving the stresses and compressive forces resulting from the corresponding crimped projection member 14, the optimum alignment position 31 often corresponding to the center of the channel 27. The axial-spacing of the projection members 14 and the channels 27 must correspond in a predetermined manner. In other words, the axial spacing of the projection members 14 is dependent on the axial spacing of the channels 27, and vice versa. Each projection member 14 is paired with a corresponding channel 27. Prior to the crimping operation, the axial spacing of the projection members 14 on the ferrule 11 is smaller than the axial spacing of the channels 27 on the shank 23, such that the projection members 14 are not properly aligned with the optimum alignment positions 31 of the channels 27. Upon performance of the crimping operation, the sleeve body 12 elongates, such that the axial spacing between the projection members 14 is expanded and the projection members 14 are now properly spaced and aligned with the channels 27.

To attach the fitting 10, the shank 23 of the stem member 21 is inserted into the hose bore 92 of the flexible hose 90, such that the hose end 91 abuts against the interlock shoulder 25, the external diameter of the shank 23 having been chosen to properly correspond to the diameter of the hose bore 92. The ferrule 11 is disposed around the hose end 91 such that the interconnecting flange member 13 of the ferrule 11 is properly aligned with the interlock groove 26 of the stem member 21, as shown in FIG. 1. Upon crimping or through an alternative joining operation, deformation of the ferrule 11 results in the joining of the interconnecting flange 13 of the ferrule 11 to the interlock groove 26 of the stem member 21, securing the ferrule 11 to the stem member 21 to preclude relative axial movement and thereby creating the complete fitting 10, as shown in FIG. 2. The deformation of the sleeve body 12 in the radial direction compresses the hose 90 between the sleeve body 12 and the shank 23, while simultaneously elongating the sleeve body 12 such that the axial spacing of the projection members 14 is increased to the point where the axial spacing of the projection members 14 corresponds and aligns with the axial spacing of the channels 27, and the projection members 14 align with the optimum alignment position 31 of the channels 27 such that the paired projection members 14 and channels 27 now correspond and optimal securing of the fitting 10 to the hose 90 is achieved.

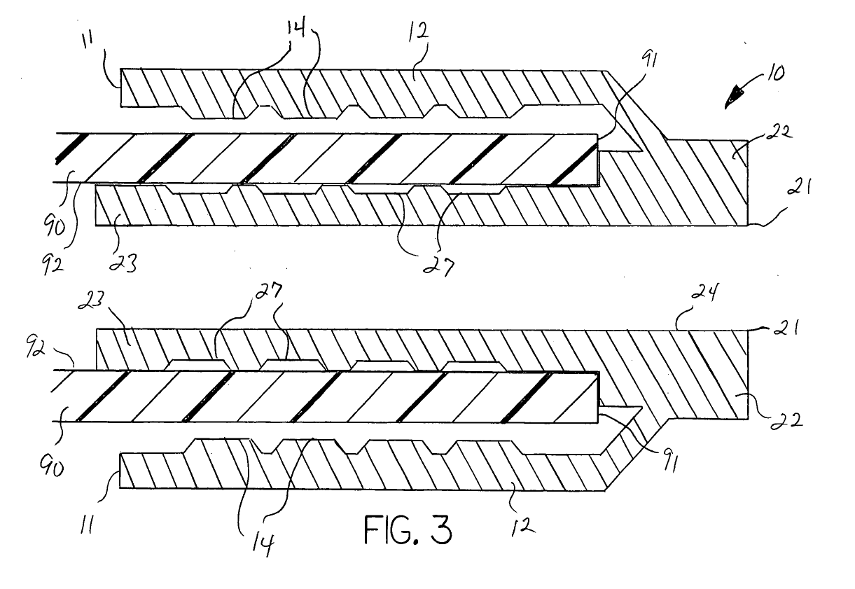

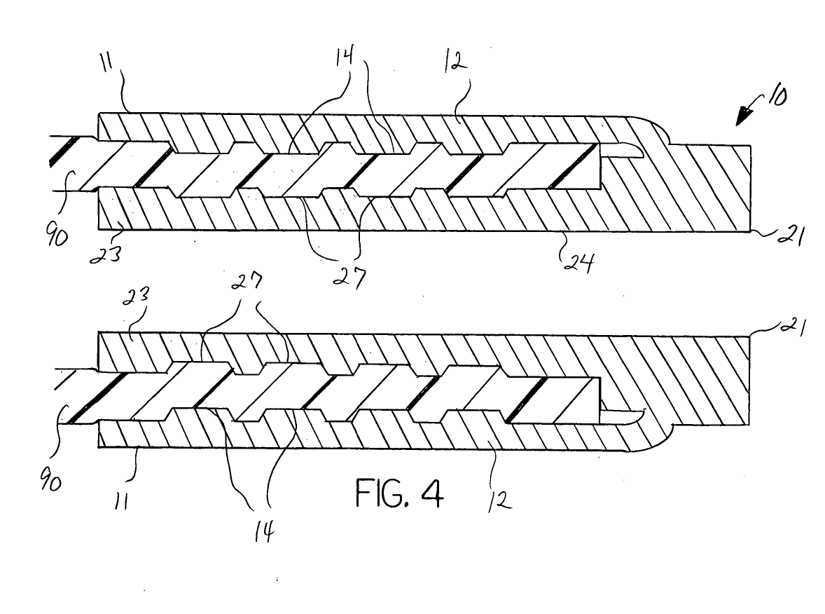

FIGS. 3 and 4 illustrate an alternative embodiment wherein the fitting 10 is composed of a ferrule 11 joined directly to the stem member 21, such as by welding, or formed as a unitary component. As before, in the neutral configuration prior to performance of the crimping operation, the axial spacing of the projection members 14 is less than that of the channels 27, but upon deformation and elongation the axial spacing of the projection. members 14 is properly adjusted such that they properly align with the channels 27.

As a representative and illustrative example, a fitting 11 may comprise a stem member 21 having four channels 27 with angled sides disposed on the shank 23, the channels 27 being approximately 0.10 inches in width at the shank surface, approximately 0.08 inches in width at the bottom, and approximately 0.01 inches in depth. The optimum alignment position 31 of a first channel 27 is 0.147 inches from the interlock shoulder 25, that of the second channel 27 from the first channel 27 is 0.154 inches, that of the third channel 27 from the second channel 27 is 0.154 inches,. and that of the fourth channel 27 from the third channel 27 is 0.154 inches. The corresponding ferrule 11 has projection members 14 each having a generally perpendicular or slightly angled wall approximately 0.01 inches in height, a width of approximately 0.02 inches, and an angled wall extending toward the interior of the hose 90. In the neutral, pre-crimped status, the axial distance from the interlock shoulder 25 to the first projection member 14, measured to its midpoint, is approximately 0.135 inches, that of the second projection member 14 from the first projection member 27 is approximately 0.143, that of the third projection member 14 from the second projection member 14 is approximately 0.143 inches, and that of the fourth projection member 14 from the third projection member 14 is approximately 0.143 inches. In other words, the axial separation distance between the channels 27 is approximately 0.154 inches and the axial separation distance between the projection members 14 is approximately 0.143 inches, a reduction of approximately seven percent. When the ferrule sleeve body 12 is deformed radially inward in the crimping operation, the sleeve body elongates approximately 7 percent, thereby increasing the axial spacing between the projection members 14 to approximately 0.154 inches, which corresponds to the axial spacing of the channels 27. In this manner the projection members 14 are properly aligned with the channels 27 in the post-crimped status. As previously stated, actual dimensions may vary greatly dependent upon many factors of choice, including hose size, hose composition, configuration of the channels 27, configuration of the projection members 14, etc. Likewise, the axial separation distances between the channels 27 does not have to be uniform between each adjoining set of channels 27.

Attaching a fitting 10 to a hose 90 in the described manner results in less compression and deformation of the hose 90, since the hose 90 flows in a waffle-like or undulating manner.

It is understood and contemplated that equivalents and substitutions to certain elements set forth above may be obvious to those skilled in the art, and therefore the true scope and definition of the invention is to be as set forth in the following claims.

I claim:

1. A flexible hose fitting comprising a ferrule composed of a malleable metal and a stem member, wherein crimping said ferrule elongates said ferrule and secures said fitting to a flexible hose;
said stem member comprising at least one annular channel;
said ferrule comprising at least one annular projection member, wherein said at least one annular projection member is positioned on said ferrule such that said at least one annular projection member is not aligned with said at least one annular channel prior to crimping said ferrule, and wherein said at least one annular projection member is aligned with said at least one annular channel after crimping said ferrule.

2. The fitting of claim 1, wherein said ferrule comprises a sleeve body and said at least one annular projection member is disposed on the interior of said sleeve body, and wherein said stem member comprises a shank and said at least one annular channel is disposed on the exterior of said shank.

3. The fitting of claim 1, wherein said ferrule and said stem member are a unitary member.

4. The fitting of claim 1, wherein said ferrule expands by approximately seven percent during crimping.

5. The fitting of claim 1, wherein said at least one annular projection member and said at least one annular channel are continuous over 350 degrees.

6. A flexible hose fitting comprising a ferrule composed of a malleable metal and a stem member, wherein crimping said ferrule elongates said ferrule and secures said fitting to a flexible hose;
said stem member comprising a plurality of annular channels;
said ferrule comprising a plurality of annular projection members, wherein said annular projection members are positioned on said ferrule such that said annular projection members are not aligned with said annular channels prior to crimping said ferrule, and wherein said annular projection members are aligned with said channels after crimping said ferrule.

7. The fitting of claim 6, wherein said ferrule comprises a sleeve body and said plurality of annular projection members is disposed on the interior of said sleeve body, and wherein said stem member comprises a shank and said plurality of annular channels is disposed on the exterior of said shank.

8. The fitting of claim 6, wherein said ferrule and said stem member are separate members joined by crimping.

9. The fitting of claim 6, wherein said ferrule and said stem member are a unitary member.

10. The fitting of claim 6, wherein said annular projection members and said annular channels are continuous over 350 degrees.

11. The fitting of claim 6, wherein said ferrule expands by approximately seven percent during crimping.

12. The fitting of claim 6, wherein each said annular channel member comprises an optimum alignment position, and wherein said annular projection members are aligned with said optimum alignment positions of said channels after crimping said ferrule.

13. The fitting of claim 6, wherein said annular channels and said annular projection members are provided as pairs.

14. A flexible hose fitting comprising a ferrule composed of a malleable metal and a stem member, wherein crimping said ferrule secures said fitting to a flexible hose;
said stem member comprising a plurality of annular channels, each said channel being separated from an adjoining channel by a separation distance;
said ferrule comprising a plurality of annular projection members , each said annular projection member corresponding to one of said channel members, whereby upon crimping said ferrule said ferrule elongates and each said projection member aligns with said corresponding one of said channels, each said projection member being separated from an adjoining projection member by a separation distance;
wherein said separation distance of said projection members is smaller than said separation distance of corresponding channel members prior to crimping said ferrule, and wherein said separation distance of said projection members is equal to said separation distance of corresponding channel members after crimping said ferrule.

15. The fitting of claim 14, wherein said ferrule comprises a sleeve body and said plurality of annular projection members is disposed on the interior of said sleeve body, and wherein said stem member comprises a shank and said plurality of annular channels is disposed on the exterior of said shank.

16. The fitting of claim 14, wherein said ferrule and said stem member are a unitary member.

17. The fitting of claim 14, wherein said annular projection members and said annular channels; are continuous over 350 degrees.

18. The fitting of claim 14, wherein said ferrule expands by approximately seven percent during crimping.

19. The fitting of claim 18, wherein said separation distance of said projection members is approximately seven percent smaller than said separation distance of corresponding channel members prior to crimping said ferrule

20. The fitting of claim 14, wherein each said annular channel member comprises an optimum alignment position, and wherein said annular projection members are aligned with said optimum alignment positions of said channels after crimping said ferrule.
